(19) United States
(12) Patent Application Publication
(10) Pub. No.: US 2025/0208356 A1
(43) Pub. Date: Jun. 26, 2025

(54) OPTICAL CONNECTION STRUCTURE, ADAPTOR AND OPTICAL CONNECTOR

(71) Applicants: SUMITOMO ELECTRIC INDUSTRIES, LTD., Osaka- shi, Osaka (JP); SUMITOMO ELECTRIC OPTIFRONTIER CO., LTD., Yokohama-shi, Kanagawa (JP); NIPPON TSUSHIN DENZAI CO., LTD., Komaki-shi, Aichi (JP)

(72) Inventors: Motoyoshi KIMURA, Komaki-shi (JP); Daichi YAMADA, Komaki-shi (JP); Yasuyuki MAEKAWA, Yokohama-shi (JP); Junji FUKUI, Yokohama-shi (JP); Shunichi WATANABE, Osaka-shi (JP); Masaki OMURA, Osaka-shi (JP); Takayuki YOKOCHI, Osaka-shi (JP); Kenichiro OTSUKA, Osaka-shi (JP)

(73) Assignees: SUMITOMO ELECTRIC INDUSTRIES, LTD., Osaka- shi, Osaka (JP); SUMITOMO ELECTRIC OPTIFRONTIER CO., LTD., Yokohama-shi, Kanagawa (JP); NIPPON TSUSHIN DENZAI CO., LTD., Komaki-shi, Aichi (JP)

(21) Appl. No.: 18/848,690

(22) PCT Filed: Mar. 31, 2022
(86) PCT No.: PCT/JP2022/016581

§ 371 Date: Sep. 19, 2024

(51) Int. Cl. G02B 6/38

(52) U.S. Cl. CPC G02B 6/3825; G02B 6/3885; G02B 6/3893; G02B 6/3897

(57) ABSTRACT

A first optical connector which is provided with a plurality of first ferrules and a first connector housing that houses the plurality of first ferrules; a second optical connector which is provided with a plurality of second ferrules and a second connector housing that houses the plurality of second ferrules; and an adaptor which has a tubular shape, and which engages with the first optical connector and the second optical connector such that the first optical connector and the second optical connector face each other inside the tubular shape when inserted inside the tubular shape and each of a plurality of first optical fibers are optically coupled to a corresponding one of a plurality of second optical fibers. In this optical connection structure, provided to the adaptor is a first latch release mechanism that releases the engagement of the first optical connector engaged with the adaptor.

### TECHNICAL FIELD

The present disclosure relates to an optical connection structure, an adapter, and an optical connector.

### BACKGROUND ART

Patent literature 1 discloses an optical connection structure for connecting an optical connector holding a plurality of ferrules to an adapter. Patent literature 2 to patent literature 6 disclose an optical connection structure including an optical connector that holds a plurality of ferrules.

### CITATION LIST

### Patent Literature

Patent literature 1: U.S. Patent Application Publication No. 2021-0255403
Patent literature 2: U.S. Pat. No. 10,914,899
Patent literature 3: U.S. Pat. No. 8,992,097
Patent literature 4: U.S. Pat. No. 10,359,579
Patent literature 5: U.S. Pat. No. 10,670,824
Patent literature 6: U.S. Pat. No. 10,598,870

### SUMMARY OF THE INVENTION

The present disclosure discloses an optical connection structure. The optical connection structure includes a first optical connector including a plurality of first ferrules each configured to hold a plurality of first optical fibers, and a first connector housing configured to house and hold the plurality of first ferrules; a second optical connector including a plurality of second ferrules each configured to hold a plurality of second optical fibers, and a second connector housing configured to house and hold the plurality of second ferrules; and an adapter having a tubular shape and configured such that the first optical connector and the second optical connector are locked to the adapter in such a manner that the first optical connector and the second optical connector inserted into the tubular shape face each other inside the tubular shape to optically couple each of the plurality of first optical fibers to a corresponding optical fiber of the plurality of second optical fibers. In this optical connection structure, the adapter is provided with a first latch release mechanism configured to release locking of the first optical connector locked to the adapter.

### BRIEF DESCRIPTION OF THE DRAWINGS

FIG. 1 is a perspective view showing an optical connection structure according to an embodiment.

FIG. 2 is a cross-sectional view of the optical connection structure taken along line II-II shown in FIG. 1.

FIG. 3 is a perspective view showing a state before an optical connector is connected to an adapter in the optical connection structure shown in FIG. 1.

FIG. 4 is a perspective view of the optical connector according to an embodiment.

FIG. 5 is an exploded perspective view of the optical connector shown in FIG. 4.

FIG. 6 is a sectional perspective view of a ferrule of the optical connector shown in FIG. 4.

FIG. 7 is a cross-sectional perspective view of a front connector housing of the optical connector shown in FIG. 4.

FIG. 8 is a perspective view showing the optical connector from which the front connector housing is removed, shown in FIG. 4.

FIG. 9 is a diagram showing an example of the arrangement of the ferrules in the optical connector shown in FIG. 4.

FIG. 10 is a diagram showing another example of the arrangement of the ferrules in the optical connector shown in FIG. 4.

FIG. 11 is a perspective view showing the adapter according to an embodiment.

FIG. 12 is an exploded perspective view of the adapter shown in FIG. 11.

FIG. 13 is a perspective view showing an adapter body of the adapter shown in FIG. 11.

FIG. 14 is a perspective view of the adapter body shown in FIG. 13 as viewed from another angle.

FIG. 15 is a perspective view showing a latch release member of the adapter shown in FIG. 11.

FIG. 16 is a sectional perspective view showing the vicinity of the latch member of the adapter shown in FIG. 11 in an enlarged manner.

### DETAILED DESCRIPTION

### Problems to be Solved by Present Disclosure

In the optical connection structure disclosed in patent literature 1, a member for locking and releasing for connection to an adapter is provided outward of an optical connector that holds a plurality of ferrules, and the size of the optical connector increases. Thus, in an application in which an optical connector attachable to and detachable from an adapter and having a large number of optical fibers installed therein is connected to the adapter through a narrow space, the routing property of the optical connector is deteriorated, and the working efficiency is lowered. Thus, an optical connection structure, an adapter, and an optical connector are desired, which can improve the working efficiency when the optical connector is attached to the adapter or the like.

### Advantageous Effects of Present Disclosure

According to the present disclosure, the working efficiency can be improved when an optical connector is attached to an adapter or the like.

### Description of Embodiments of Present Disclosure

First, the contents of embodiments of the present disclosure will be listed and explained. An optical connection structure according to one embodiment of the present disclosure includes a first optical connector including a plurality of first ferrules each configured to hold a plurality of first optical fibers, and a first connector housing configured to house and hold the plurality of first ferrules; a second optical connector including a plurality of second ferrules each configured to hold a plurality of second optical fibers, and a second connector housing configured to house and hold the plurality of second ferrules; and an adapter having a tubular shape and configured such that the first optical connector and the second optical connector are locked to the adapter in such a manner that the first optical connector and the second optical connector inserted into the tubular shape face each other inside the tubular shape to optically couple each of the plurality of first optical fibers to a corresponding optical fiber of the plurality of second optical fibers. In this optical connection structure, the adapter is provided with a first latch release mechanism configured to release locking of the first optical connector locked to the adapter.

In this optical connection structure, the adapter is provided with the first latch release mechanism configured to release locking of the first optical connector locked to the adapter. According to the embodiment, the latch release mechanism, which tends to increase the size of the structure and the size of the device, does not have to be provided in the first optical connector, and thus the first optical connector can be miniaturized. When the first optical connector is small, the first optical connector that is attachable and detachable is improved in the routing property in the application of connecting to the adapter or the like through a narrow place. The working efficiency can be improved when the first optical connector is attached to the adapter or the like.

As one embodiment of the optical connection structure, the adapter may include an adapter body including a first latch member configured to lock the first optical connector; and a first latch release member to be attached to the adapter body in such a manner as to be movable along a first direction, the first latch release member including a first latch release structure. The first latch release structure may constitute a portion of the first latch release mechanism and be configured to release locking of the first optical connector locked to the adapter when the first latch release member moves in a direction away from the adapter body along the first direction. According to this embodiment, the locking of the first optical connector can be released by a simple means in the adapter.

As one embodiment of the optical connection structure, the first latch member may include a pair of first latch members, and the first latch release structure may include two pairs of first latch release structures. According to this embodiment, the locking of the first optical connector can be released by a simple means in the adapter

As one embodiment of the optical connection structure, the adapter body may further include a frame having an opening thereinside. The first latch member may include a first latch body extending outward from the frame along the first direction, and a first protruding portion protruding inward from a tip of the first latch body along a second direction intersecting the first direction. In the optical connection structure according to this embodiment, the first protruding portion may engage with a latch receiving portion of the first optical connector to lock the first optical connector to the adapter. According to this embodiment, the adapter can lock the first optical connector thereto by a simple means.

As one embodiment of the optical connection structure, the first latch release mechanism may be configured to move the first protruding portion of the first latch member outward when the first latch release member moves in the direction away from the adapter body along the first direction. According to this embodiment, the locking of the first optical connector can be released in the adapter by a simple operation.

As one embodiment of the optical connection structure, the first latch member may include a second latch release structure provided beside the first protruding portion, the first latch release structure and the second latch release structure may constitute the first latch release mechanism. In the optical connection structure according to this embodiment, when the first latch release member moves in the direction away from the adapter body along the first direction, the first latch release structure may come into contact with the second latch release structure and push the first protruding portion outward to release the locking of the first optical connector locked to the adapter. According to this embodiment, the locking of the first optical connector can be more reliably released in the adapter.

As one embodiment of the optical connection structure, the adapter may further include a first guide member configured to restrict a distance by which the first latch release member moves in the direction away from the adapter body along the first direction and guide insertion of the first optical connector into the adapter. According to this embodiment, by limiting the moving range of the first latch release member, the latch release operation can be performed in a narrow range, and the first optical connector can be smoothly inserted into the adapter.

As one embodiment of the optical connection structure, an elastic member may be disposed between the first latch release member and the first guide member, and the elastic member may act to return the first latch release member toward the adapter body after the first latch release member moves in the direction away from the adapter body. According to this embodiment, the return motion after the locking of the first optical connector is released can be realized by a simple means in the adapter.

As one embodiment of the optical connection structure, the first guide member may be provided with a restricting structure configured to restrict an insertion posture of the first optical connector with respect to the adapter. For example, the end surface of the ferrule held by the first optical connector may be an inclined surface for preventing reflected return light or the like. In this case, it is necessary to connect the first optical connector to the adapter or optically couple the first optical connector to the second optical connector in a state where the posture of the first optical connector in the up-and-down direction is adjusted. In this embodiment, since the structure for regulating such a posture is pre-provided in the adapter, there is no risk of inserting the first optical connector into the adapter in the wrong posture. As described above, according to the embodiment of the present disclosure, since it is not necessary to care about the posture such as the up-and-down direction when the first optical connector is inserted into the adapter, the working efficiency can be improved when the first optical connector is attached to the adapter.

As one embodiment of the optical connection structure, the adapter may be provided with a second latch release mechanism configured to release locking of the second optical connector locked to the adapter. According to this embodiment, the latch release mechanism, which tends to increase the size of the structure and the size of the device, does not have to be provided in the second optical connector, and thus the second optical connector can also be miniaturized. When the second optical connector is small, the routing property of the second optical connector is also improved in the application of connecting to the adapter or the like through a narrow place. The working efficiency can be improved when the second optical connector is attached to the adapter or the like.

As one embodiment of the optical connection structure, the adapter may include a second latch release member to be attached to the adapter body at a position on an opposite side of the adapter body to a first latch release member along a first direction in such a manner as to be movable along the first direction, the second latch release member including two pairs of third latch release structures; and a second guide member configured to restrict a distance by which the second latch release member moves in a direction away from the adapter body along the first direction and guide insertion of the second optical connector into the adapter. The adapter body may include a pair of second latch members configured to lock the second optical connector. Each of the pair of second latch members may include a second latch body extending along the first direction, a second protruding portion protruding inward from a tip of the second latch body along a second direction intersecting the first direction, and a pair of fourth latch release structures provided on both sides of the second protruding portion. The two pairs of third latch release structures and the pair of fourth latch release structures of each of the pair of second latch members may constitute the second latch release mechanism. When the second latch release member moves in the direction away from the adapter body along the first direction, the two pairs of third latch release structures may come into contact with the pair of fourth latch release structures of each of the pair of second latch members and push the second protruding portion outward to release the locking of the second optical connector locked to the adapter. According to this embodiment, the locking of the second optical connector can be more reliably released by a simple means in the adapter.

An adapter according to one embodiment of the present disclosure is an adapter to which a first optical connector holding a plurality of first ferrules and a second optical connector holding a plurality of second ferrules are to be locked. The adapter includes an adapter body including a first latch member configured to lock the first optical connector; and a first latch release member to be attached to the adapter body in such a manner as to be movable along a first direction, the first latch release member including a first latch release structure. The first latch release structure is configured to release locking of the first optical connector locked to the adapter by the first latch member when the first latch release member moves in a direction away from the adapter body along the first direction. In this adapter, the locking of the first optical connector can be released by the first latch release member with a simple means.

In the adapter according to one embodiment of the present disclosure, the first latch member may include a pair of first latch members, and the first latch release structure may include two pairs of first latch release structures. In this adapter, the locking of the first optical connector can be released by the first latch release member with a simple means.

As one embodiment of the adapter, the adapter body may further include a frame having an opening thereinside. The first latch member may include a first latch body extending outward from the frame along the first direction, and a first protruding portion protruding inward from a tip of the first latch body along a second direction intersecting the first direction. The first protruding portion may engage with a latch receiving portion of the first optical connector to lock the first optical connector to the adapter. According to this embodiment, the adapter can lock the first optical connector thereto by a simple means.

As one embodiment of the adapter, the first latch member may include a second latch release structure provided beside the first protruding portion. When the first latch release member moves in the direction away from the adapter body along the first direction, the first latch release structure may come into contact with the second latch release structure and push the first protruding portion outward to release the locking of the first optical connector locked to the adapter. According to this embodiment, the locking of the first optical connector can be more reliably released in the adapter.

As one embodiment of the adapter, the adapter may include a first guide member configured to restrict a distance by which the first latch release member moves in the direction away from the adapter body along the first direction and guide insertion of the first optical connector into the adapter. According to this embodiment, by limiting the moving range of the first latch release member, the latch release operation can be performed in a narrow range, and the first optical connector can be smoothly inserted into the adapter.

As one embodiment of the adapter, an elastic member may be disposed between the first latch release member and the first guide member. The elastic member may act to return the first latch release member toward the adapter body after the first latch release member moves in the direction away from the adapter body. According to this embodiment, the return motion after the locking of the first optical connector is released can be realized by a simple means in the adapter.

As one embodiment of the adapter, the first guide member may be provided with a restricting structure configured to restrict an insertion posture of the first optical connector with respect to the adapter. For example, the end surface of the ferrule held by the first optical connector may be an inclined surface for preventing reflected return light or the like. In this case, it is necessary to connect the first optical connector to the adapter or optically couple the first optical connector to the second optical connector in a state where the posture of the first optical connector in the up-and-down direction is adjusted. In this embodiment, since the structure for regulating such a posture is pre-provided in the adapter, there is no risk of inserting the first optical connector into the adapter in the wrong posture. As described above, according to the embodiment of the present disclosure, since it is not necessary to care about the posture such as the up-and-down direction when the first optical connector is inserted into the adapter, the working efficiency can be improved when the first optical connector is attached to the adapter.

As one embodiment of the adapter, the adapter may further include a second latch release member disposed at a position on an opposite side of the adapter body to the first latch release member along the first direction, the second latch release member being to be attached to the adapter body in such a manner as to be movable along the first direction, the second latch release member including two pairs of third latch release structures; and a second guide member configured to restrict a distance by which the second latch release member moves in the direction away from the adapter body along the first direction and guide insertion of the second optical connector into the adapter. The adapter body may include a pair of second latch members configured to lock the second optical connector. Each of the pair of second latch members may include a second latch body extending along the first direction, a second protruding portion protruding inward from a tip of the second latch body along a second direction intersecting the first direction, and a pair of fourth latch release structures provided on both sides of the second protruding portion. When the second latch release member moves in the direction away from the adapter body along the first direction, the two pairs of third latch release structures may come into contact with the pair of fourth latch release structures of each of the pair of second latch members and push the second protruding portion outward to release locking of the second optical connector locked to the adapter. According to this embodiment, the locking of the second optical connector can be more reliably released by a simple means in the adapter.

An optical connector according to an embodiment of the present disclosure is an optical connector to be inserted into and locked to an adapter having a tubular shape. The optical connector includes a plurality of ferrules each configured to hold a plurality of optical fibers, and a connector housing configured to house and hold the plurality of ferrules. The connector housing has formed therein a latch receiving portion to which a latch member of the adapter is to be locked.

In this optical connector, the latch receiving portion is formed as a configuration for being locked to the adapter. Since the latch receiving portion is simpler in configuration and more easily miniaturized than the latch member, the optical connector attachable to and detachable from the adapter can be miniaturized. When the optical connector is small, the optical connector can be easily routed in an application where the optical connector is connected to the adapter or the like through a narrow space. The working efficiency can be improved when the optical connector is attached to the adapter or the like.

As one embodiment of the optical connector, the latch receiving portion may be a hole or a recess provided in a wall constituting the connector housing. According to this embodiment, the optical connector attachable to and detachable from the adapter can be more reliably miniaturized.

As one embodiment of the optical connector, the connector housing may include at least two or more guide surfaces on an outer peripheral surface thereof, the at least two or more guide surfaces being configured to extend along an inner peripheral surface of the adapter, and no protruding portion may be formed in a region of the at least two or more guide surfaces, the region being a region to be inserted into the adapter. According to this embodiment, the optical connector can be connected to the adapter more appropriately, and such an optical connector can be miniaturized.

As one embodiment of the optical connector, the connector housing may be provided with, on an outer peripheral surface thereof, a restricting structure configured to restrict a posture of the optical connector when the optical connector is inserted into the adapter, and the restricting structure may have a recessed shape. According to this embodiment, the posture of the optical connector can be easily adjusted when the optical connector is inserted into the adapter, and the attaching work can be facilitated.

As one embodiment of the optical connector, each of the plurality of ferrules may include a leading end surface from which the plurality of optical fibers are exposed, and the leading end surface may be inclined with respect to a plane orthogonal to a first direction, the first direction being an extending direction of a holding hole configured to hold the plurality of optical fibers. In this optical connector, the plurality of ferrules may be held in the connector housing such that all of the leading end surfaces of the plurality of ferrules are positioned on one inclined surface. According to this embodiment, all of the inclined surfaces which are the main surfaces in the plurality of ferrules constitute one surface, the inclined surfaces can be easily cleaned before the optical connector is optically coupled to another optical connector, and can be reliably cleaned. The coupling efficiency of the optical connector can be increased.

As one embodiment of the optical connector, the connector housing may include a front connector housing positioned at a front side thereof and having a rectangular parallelepiped shape, and a rear connector housing positioned at a rear side thereof. The front connector housing may include a plurality of ferrule housing holes each configured to house a corresponding one of the plurality of ferrules. The front connector housing may have four guide surfaces on an outer peripheral surface thereof, the four guide surfaces being formed to extend along an inner peripheral surface of the adapter, and no protruding portion may be formed in at least a region of the four guide surfaces, the region being a region to be inserted into the adapter. According to this embodiment, the optical connector can be miniaturized.

As one embodiment of the optical connector, the optical connector may further include a plurality of urging members configured to urge the plurality of ferrules forward, and a housing member configured to receive rear ends of the plurality of urging members and house the plurality of urging members. The housing member may include a first housing region configured to house one or more urging members of the plurality of urging members, a second housing member configured to house one or more other urging members of the plurality of urging members, and a plurality of fiber insertion holes corresponding to the plurality of ferrules, each of the plurality of fiber insertion holes being configured to allow the plurality of optical fibers held by a corresponding one of the plurality of ferrules to pass therethrough. According to this embodiment, a large number of optical fibers can be installed in one optical connector at a high density.

### Details of Embodiments of Present Disclosure

Specific examples of an optical connection structure, an adapter, and an optical connector according to the present disclosure will be described below with reference to the drawings. The present invention is not limited to these examples, but is defined by the scope of the claims, and is intended to include all modifications within the meaning and scope equivalent to the scope of the claims. In the description of the drawings. The same elements are denoted by the same reference numerals, and redundant description thereof will be omitted.

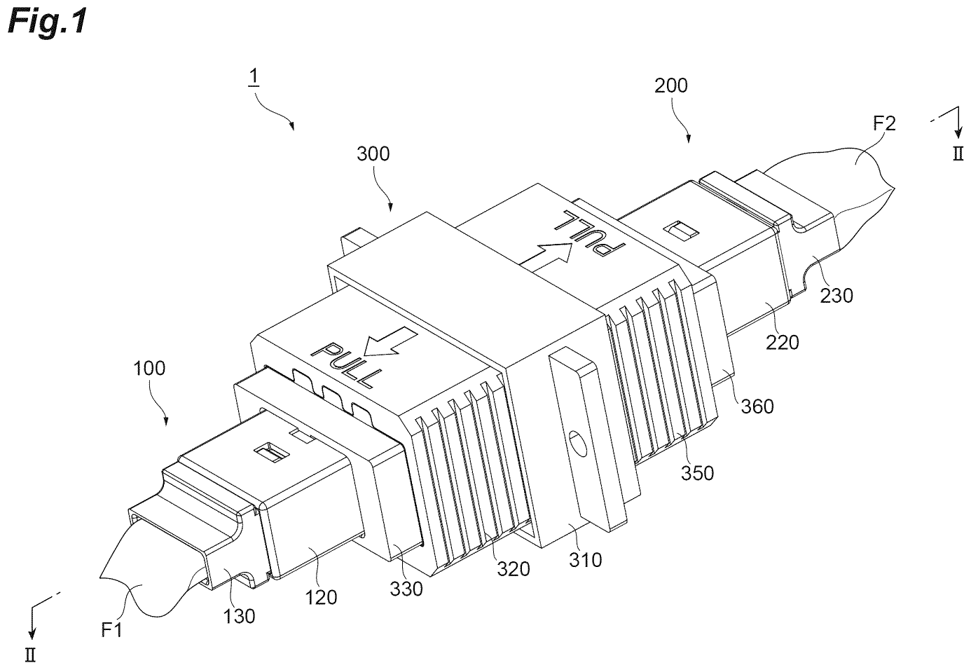

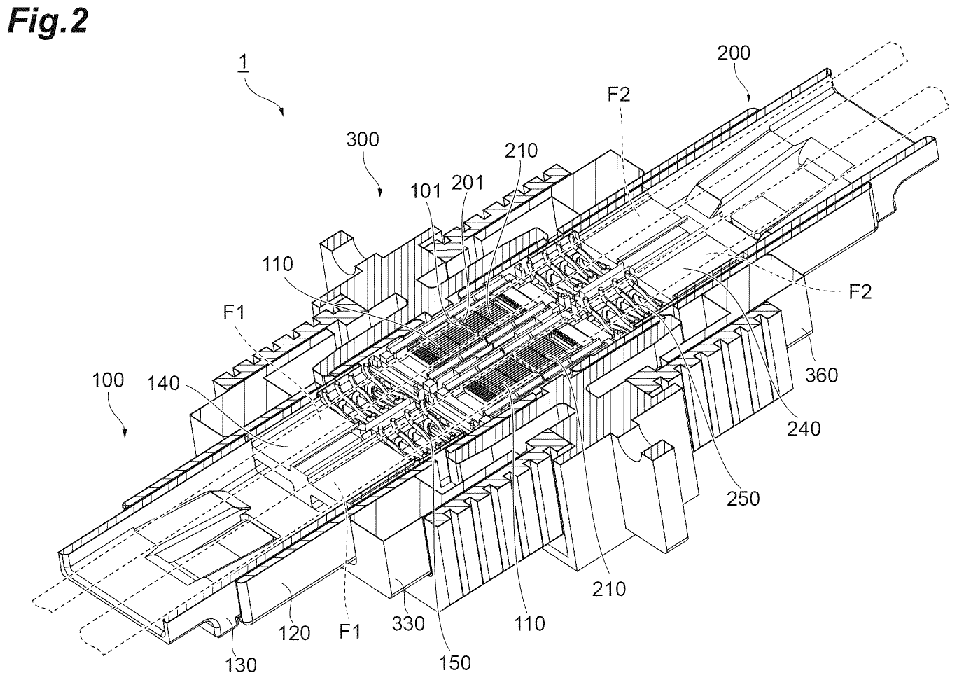

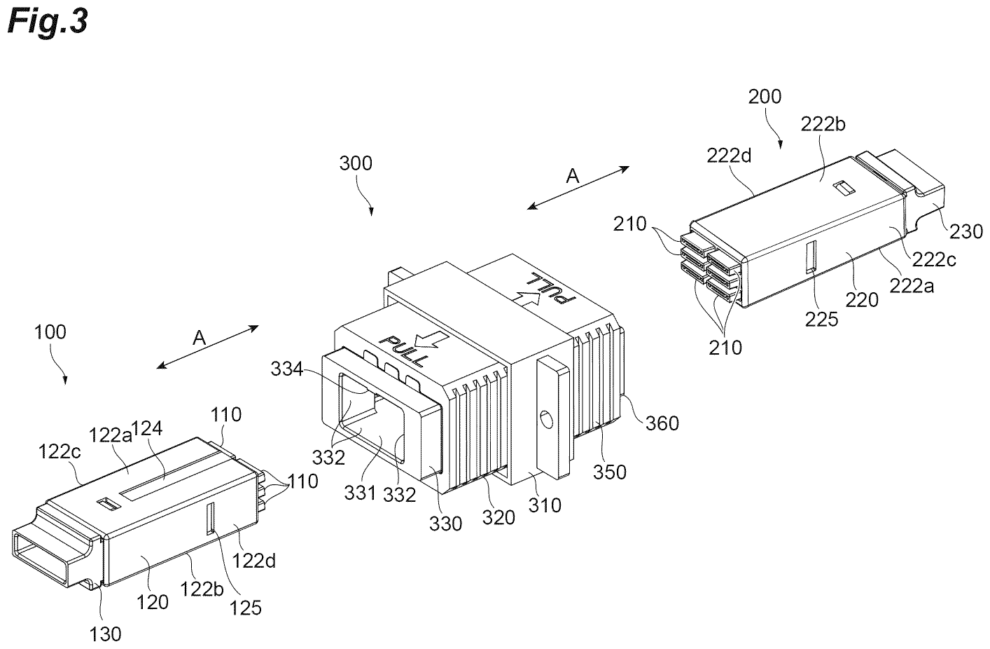

FIG. 1 is a perspective view showing an optical connection structure according to one embodiment. FIG. 2 is a cross-sectional view of the optical connection structure taken along line II-II shown in FIG. 1. FIG. 3 is a perspective view showing a state before the optical connector is connected to an adapter in the optical connection structure shown in FIG. 1. As shown in FIG. 1 to FIG. 3, an optical connection structure 1 includes a first optical connector 100, a second optical connector 200, and an adapter 300. First optical connector 100 includes a plurality of ferrules 110, and each of ferrules 110 further holds a plurality of optical fibers F1. Similarly, second optical connector 200 includes a plurality of ferrules 210, and each of ferrules 210 further holds a plurality of optical fibers F2. Ferrules 110 and 210 are, for example, an MT ferrule. In FIGS. 1 and 2, the plurality of optical fibers F1 and F2 are collectively shown, and in FIG. 3, the plurality of optical fibers F1 and F2 are omitted. It is noted that, in the example described in the embodiment of the present disclosure, first optical connector 100 and second optical connector 200 have the same structure, and thus the description thereof will not be repeated. However, first optical connector 100 and second optical connector 200 may have different configurations.

Adapter 300 has a tubular shape, and is configured such that first optical connector 100 and second optical connector 200 can be inserted from two sides of the tubular shape, as shown in FIG. 3. Adapter 300 is a connection member that locks first optical connector 100 and second optical connector 200 to adapter 300 in a state where a leading end surface 101 of first optical connector 100 and a leading end surface 201 of second optical connector 200 inserted into the tubular shape face each other inside the tubular shape, as shown in FIG. 2. The locking to adapter 300 is performed by latch members, and the details thereof will be described later. By such locking, each of the plurality of first optical fibers F1 held by first optical connector 100 locked to adapter 300 can be optically coupled to a corresponding optical fiber of the plurality of second optical fibers F2 held by second optical connector 200 locked to adapter 300.

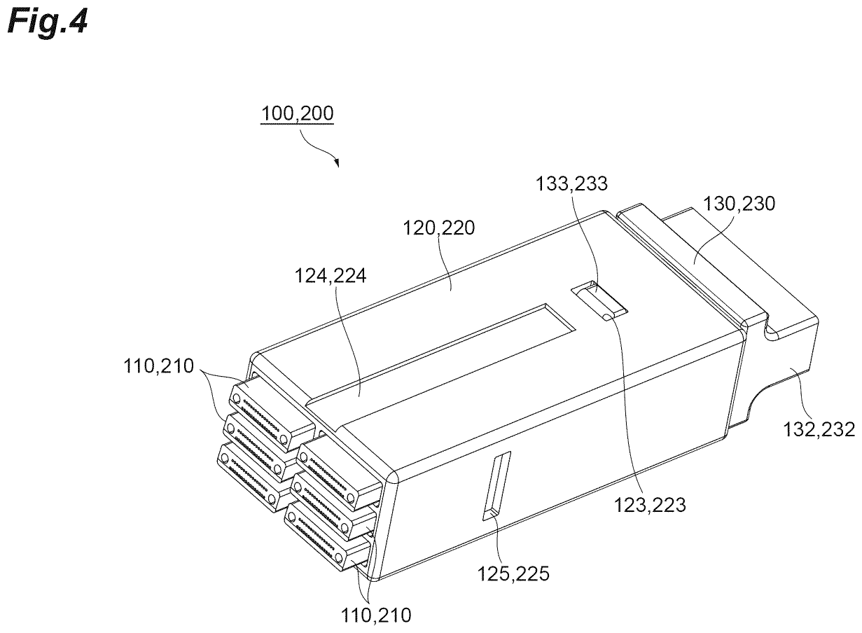

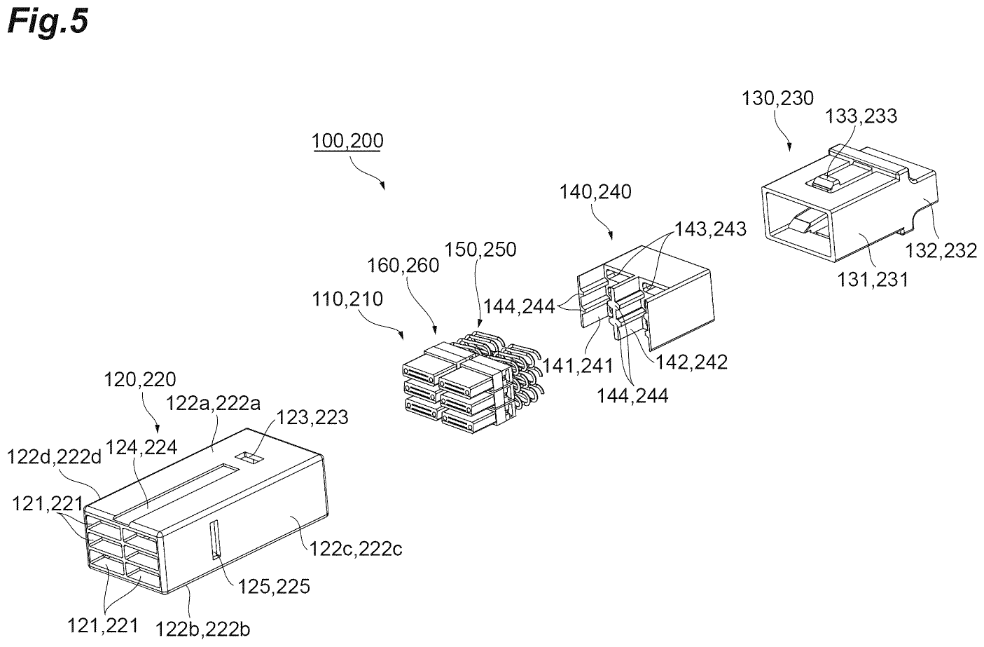

FIG. 4 is a perspective view of an optical connector according to one embodiment. FIG. 5 is an exploded perspective view of the optical connector shown in FIG. 4. As shown in FIG. 4 and FIG. 5, first optical connector 100 includes a plurality of ferrules 110, a front connector housing 120, a rear connector housing 130, a housing member 140, a plurality of urging members 150, and a plurality of pin keepers 160. Similarly, second optical connector 200 includes a plurality of ferrules 210, a front connector housing 220, a rear connector housing 230, a housing member 240, a plurality of urging members 250, and a plurality of pin keepers 260. The plurality of ferrules 110 and 210, front connector housings 120 and 220, rear connector housings 130 and 230, housing members 140 and 240, and the plurality of pin keepers 160 and 260 can be formed of a resin material such as polycarbonate (PC), polyetherimide (PEI), polyamide (PA), polyacetal (POM), polyphenylene ether (PPE), polybutylene terephthalate (PBT), polyphenylene sulfide (PPS), or polyethersulfone (PES), and can be formed of a composite material obtained by filling these resin materials with glass fibers or glass spheres. Urging members 150 and 250 may be formed of, for example, a spring. Optical connectors 100 and 200 according to the embodiment of the present disclosure includes, for example, six ferrules 110 and 210, six pin keepers 160 and 260, and six urging members 150 and 250, respectively.

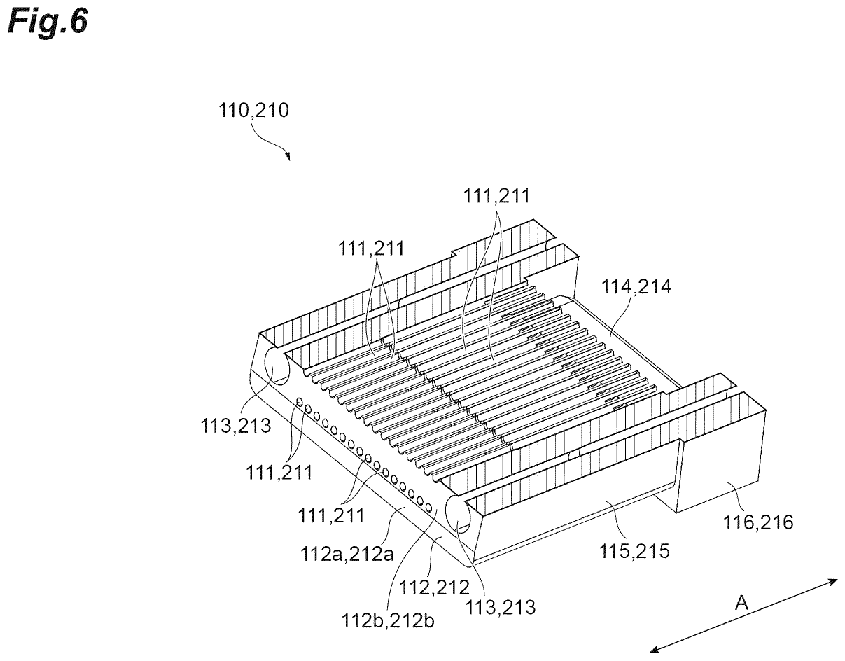

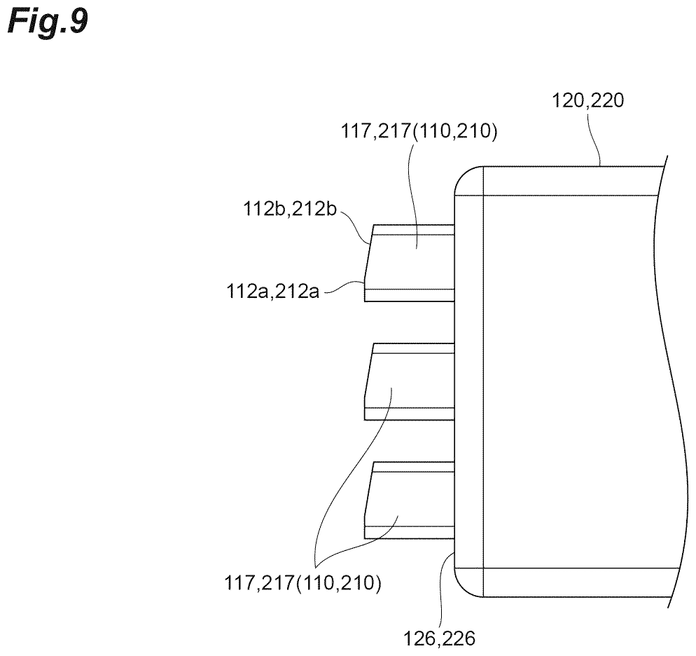

Ferrules 110 and 210 are the member that holds the plurality of optical fibers F1 and F2, respectively. FIG. 6 is a sectional perspective view showing a sectional surface of a ferrule. As shown in FIG. 5 and FIG. 6, ferrules 110 and 210 have a plurality of fiber holding holes 111 and 211 for holding optical fibers F1 and F2, leading end surfaces 112 and 212 on which the plurality of fiber holding holes 111 and 211 are exposed, a pair of guiding holes 113 and 213, and openings 114 and 214, respectively. Fiber holding holes 111 and 211 extend along an axial direction A (first direction) and hold optical fibers F1 and F2 inserted into fiber holding holes 111 and 211, respectively. The tips of optical fibers F1 and F2 held in fiber holding holes 111 and 211 are exposed from leading end surfaces 112 and 212, respectively. Ferrules 110 and 210 according to the embodiment of the present disclosure hold, for example, 32 (16×2) optical fibers F1 and F2, respectively. However, the number of optical fibers held by ferrules 110 and 210 are not limited to this. Optical fibers F1 and F2 whose tip portions are held in fiber holding holes 111 and 211 are drawn out from openings 114 and 214 to the rear side, respectively. Leading end surfaces 112 and 212 may be entirely parallel to the plane orthogonal to the axial direction A, or may include first surfaces 112a and 212a parallel to the plane orthogonal to the axial direction A and second surfaces 112b and 212b slightly inclined with respect to the plane orthogonal to the axial direction A, respectively. In this case, second surfaces 112b and 212b, which are inclined surfaces, may be inclined by, for example, 8° with respect to the plane orthogonal to the axial direction A (refer to FIG. 9). The reflected light (reflected return light) of the light output from the optical fiber can be prevented from returning the original optical fiber.

A pair of guiding holes 113 and 213 of ferrules 110 and 210 are holes for positioning the corresponding ferrules 110 and 210 when first optical connector 100 and second optical connector 200 are locked to adapter 300 and face each other. Guiding pins (not shown) are inserted into one of the pair of guiding holes 113 and 213. By inserting the guiding pins inserted into one pair of the guiding holes into the other pair of the guiding holes into which the guiding pins are not inserted, ferrule 110 and ferrule 210 are positioned with respect to each other, and optical fibers F1 held by ferrule 110 and optical fibers F2 held by ferrule 210 are optically coupled. Each rear end of the guiding pins inserted into the pair of the guiding holes protrudes from ferrule 110 or 210 to the rear side and is held by pin keepers 160 and 260 which are disposed on the rear side of ferrules 110 and 210.

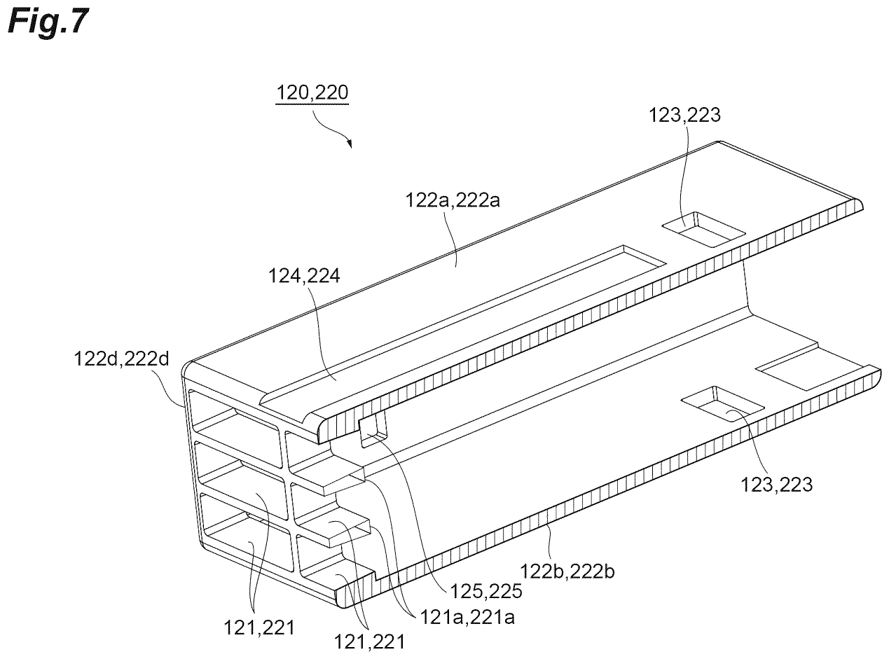

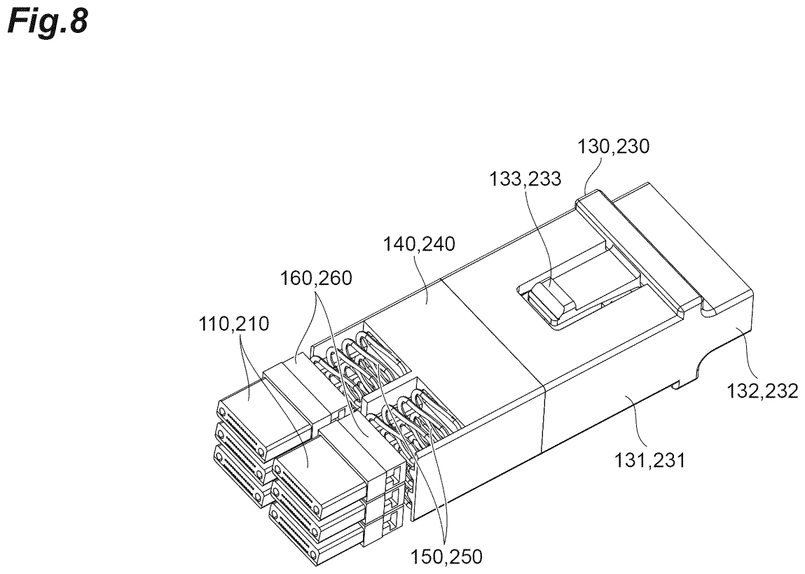

Front connector housings 120 and 220 are housings having a rectangular parallelepiped shape and positioned at the front side of optical connectors 100 and 200, respectively. FIG. 7 is a cross-sectional perspective view of the front connector housing, with a portion thereof being in cutaway. As shown in FIG. 5 and FIG. 7, front connector housings 120 and 220 have a plurality of ferrule housing holes 121 and 221 for individually housing a plurality of ferrules 110 and 210 on the front side, respectively. The sectional area of ferrule housing holes 121 and 221 is formed to be larger than main bodies 115 and 215 of ferrules 110 and 210, and be smaller than flanges 116 and 216 (refer to FIG. 6). With this configuration, flanges 116 and 216 are brought into contact with edge portions 121a and 221a of ferrule housing holes 121 and 221 respectively, and thus ferrules 110 and 210 inserted from the rear side with respect to ferrule housing holes 121 and 221 are prevented from being further moved forward. At this time, ferrules 110 and 210 are urged to the front side by urging members 150 and 250 as shown in FIG. 8. Ferrules 110 and 210 are held in a floating state in ferrule housing holes 121 and 221 by the urging of urging members 150 and 250 and the contact with edge portions 121a and 221a, respectively. That is, ferrules 110 and 210 are held in ferrule housing holes 121 and 221 in a state in which ferrules 110 and 210 can move in the front-and-back direction, respectively.

Front connector housings 120 and 220 have a rectangular parallelepiped shape, and have four surfaces 122a and 222a, surfaces 122b and 222b, surfaces 122c and 222c, and surfaces 122d and 222d, respectively. These four surfaces 122a to 122d and four surfaces 222a to 222d function as one guide surface when each of optical connectors 100 and 200 is inserted into adapter 300. Further, a pair of openings 123 and a pair of openings 223 are provided in surfaces 122a and 222a and surfaces 122b and 222b of front connector housings 120 and 220, respectively. A pair of engaging protrusions 133 and a pair of engaging protrusions 233 of rear connector housings 130 and 230, which will be described later, are engaged with the pair of openings 123 and 223, respectively.

Surfaces 122a and 222a of front connector housings 120 and 220 are further provided with grooves 124 and 224 extending along the axial direction A, respectively. Grooves 124 and 224 are the structure for regulating the insertion posture (up-and-down direction) of optical connectors 100 and 200 when each of optical connectors 100 and 200 is inserted into adapter 300, respectively, and are engaged with a protrusion provided with adapter 300. In addition, latch receiving portions 125 and 225 formed of a pair of openings are provided with surfaces 122c and 222c and surfaces 122d and 222d of the front connector housing, respectively, at a position closer to the front side. Latch receiving portions 125 and 225 penetrates through each of the wall portion including surfaces 122c and 222c and the wall portion including surfaces 122d and 222d, respectively, but may be a recessed shape which is a non-penetrating. When latch receiving portions 125 and 225 have a recessed shape, latch receiving portions 125 and 225 have a shape recessed from surfaces 122c and 222c and surfaces 122d and 222d toward the inside, respectively.

Rear connector housings 130 and 230 are a tubular shape, as

shown in FIG. 4, FIG. 5 and FIG. 8, and have front portions 131 and 231 and rear portions 132 and 232, respectively. Front portions 131 and 231 are accommodated inside front connector housings 120 and 220, and rear portions 132 and 232 are positioned at the rear side outside front connector housings 120 and 220, respectively. A pair of engaging protrusions 133 and a pair of engaging protrusions 233 are provided on the upper and lower surfaces of front portions 131 and 231, respectively. Rear connector housings 130 and 230 are fixed to front connector housings 120 and 220 by engaging a pair of engaging protrusions 133 and a pair of engaging protrusions 233 with a pair of openings 123 and a pair of openings 223 of front connector housings 120 and 220, respectively. At this time, the plurality of ferrules 110 and 210, the plurality of pin keepers 160 and 260, the plurality of urging members 150 and 250, housing members 140 and 240, and front portions 131 and 231 of rear connector housings 130 and 230, which are shown in FIG. 8, are housed in front connector housings 120 and 220, respectively. Rear connector housings 130 and 230 have a hollow shape, and optical fibers F1 and F2 are inserted through rear connector housings 130 and 230 respectively and drawn out to the rear side.

As shown in FIG. 5 and FIG. 8, housing members 140 and 240 are the member that receives the rear ends of the plurality of urging members 150 and the plurality of urging members 250 and houses the plurality of urging members 150 and the plurality of urging members 250, respectively. Housing member 140 is positioned between the plurality of ferrules 110 and 210 and rear connector housing 130 and 230 respectively. In addition, the rear end of housing member 140 is supported by the front end of rear connector housings 130 and 230. Housing members 140 and 240 may be formed as a member integrated with rear connector housings 130 and 230, respectively. Housing members 140 and 240 include first housing regions 141 and 241 that house one group (three urging members on the left side in the drawing) of urging members 150 and 250, second housing regions 142 and 242 that house the other group (three urging members on the right side in the drawing) of urging members 150 and 250, and a plurality of fiber insertion holes 143 and 243 which correspond to ferrules 110 and 210 and through which each of optical fibers F1 and F2 held by the plurality of ferrules 110 and 210 can pass through, respectively. Fiber insertion holes 143 and 243 penetrate to the rear side. Although each of first housing regions 141 and 241 and each of second housing regions 142 and 242 are formed as one region (spatially connected), protrusions 144 and 244 functioning as a partition capable of individually housing urging members to be housed may be provided.

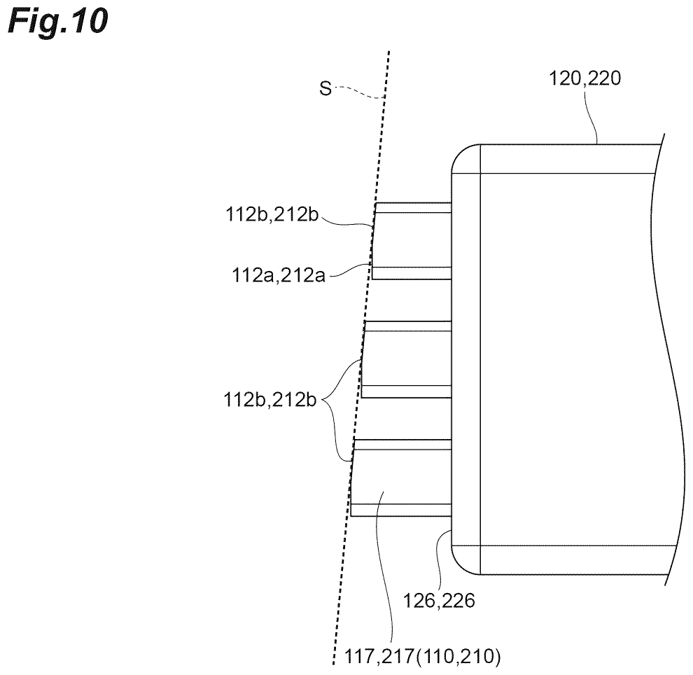

In optical connectors 100 and 200 having the above-described configuration, as shown in FIG. 9, each of ferrules 110 and 210 is held such that a front end portions 117 and 217 protrude from leading end surfaces 126 and 226 of front connector housings 120 and 220, respectively. In the example shown in FIG. 9, the protruding amounts of front end portions 117 and 217 of ferrules 110 and 210 protruding from leading end surfaces 126 and 226 are uniform. However, as shown in FIG. 10, the protruding amounts of front end portions 117 and 217 of ferrules 110 and 210 protruding from leading end surfaces 126 and 226 may be increased, for example, from the top to the bottom, and all of second surfaces 112b and 212b (inclined surfaces) of ferrules 110 and 210 may be positioned on one reference inclined surface S (coincide with the reference inclined surface). In this case, leading end surfaces 112 and 212 (second surfaces 112b and 212b) where optical fibers F1 and F2 are exposed are aligned on one surface, and thus the cleaning work of leading end surfaces 112 and 212 of the ferrules and the tips of optical fibers F1 and F2 is easily performed.

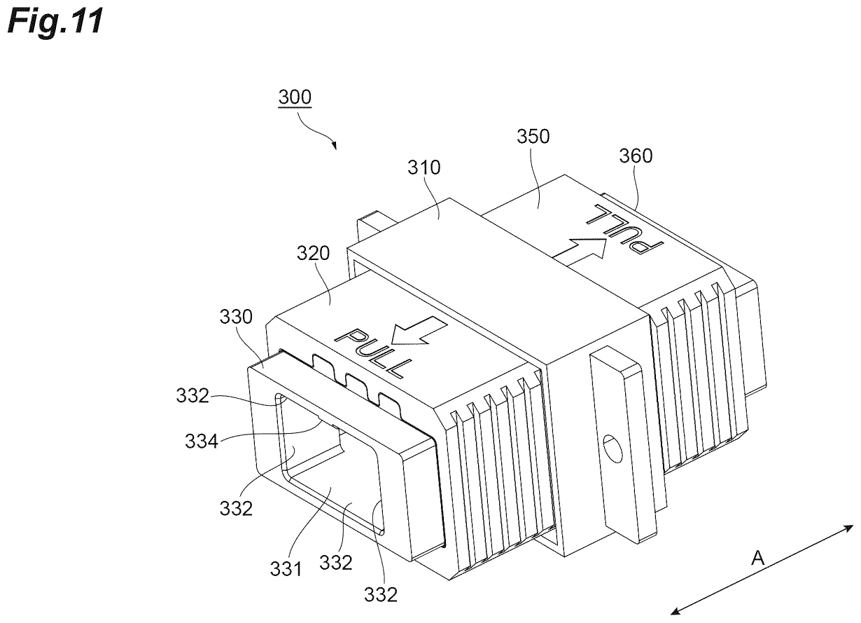

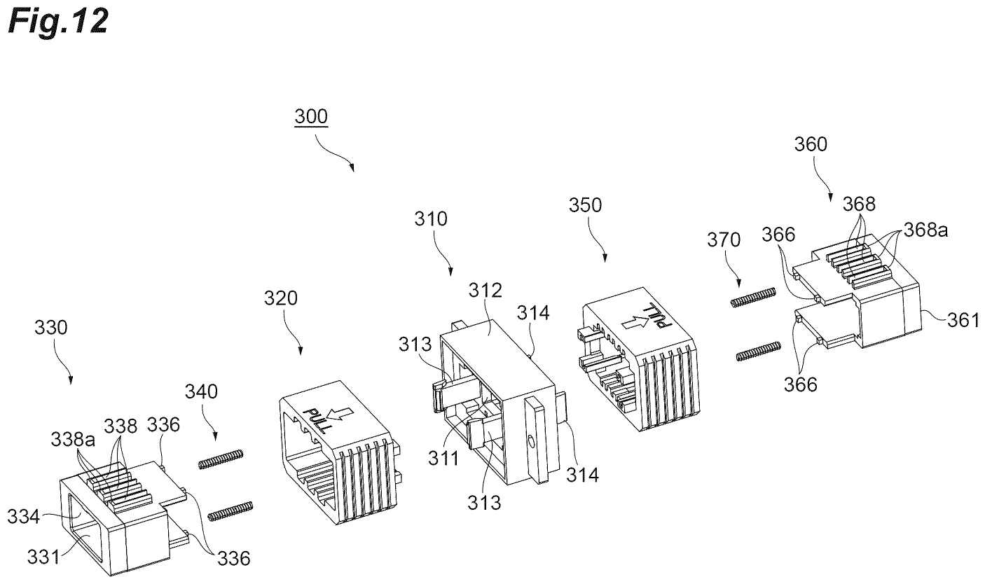

Next, referring to FIG. 11 and FIG. 12, adapter 300 capable of locking and latch-releasing first optical connector 100 and second optical connector 200 by a latch member will be described. FIG. 11 is a perspective view showing the adapter according to one embodiment. FIG. 12 is an exploded perspective view of the adapter shown in FIG. 11. As shown in FIG. 11 and FIG. 12, adapter 300 includes an adapter body 310, a first latch release member 320, a first guide member 330, a first elastic member 340, a second latch release member 350, a second guide member 360, and a second elastic member 370. Adapter body 310, first latch release member 320, first guide member 330, second latch release member 350, and second guide member 360 can be formed of a resin material such as polycarbonate (PC), polyetherimide (PEI), polyamide (PA), polyacetal (POM), polyphenylene ether (PPE), polybutylene terephthalate (PBT), polyphenylene sulfide (PPS), or polyethersulfone (PES), and can be formed of a composite material obtained by filling these resin materials with glass fibers or glass spheres. First elastic member 340 and second elastic member 370 can be formed of, for example, springs.

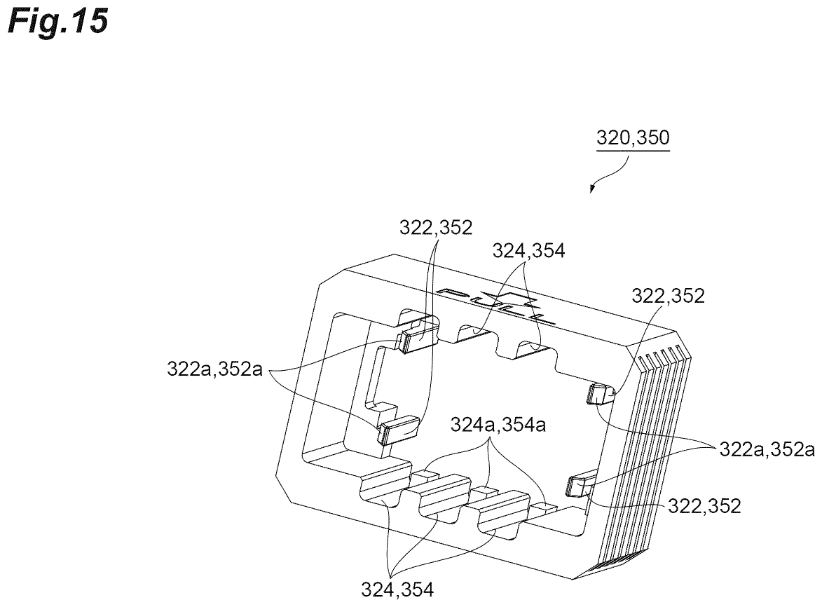

In adapter 300, first latch release member 320 is attached to adapter body 310 so as to be slightly slidable along an insertion/attaching and detaching direction A (the same as axial direction A, the first direction) of first optical connector 100 with respect to adapter body 310. First guide member 330 is fixed to adapter body 310 with first latch release member 320 interposed between first guide member 330 and adapter body 310. First elastic members 340 are disposed between first latch release member 320 and first guide member 330, and first elastic members 340 urge first latch release member 320 toward adapter body 310. In adapter 300 having such a configuration, a first latch release structure 322 (refer to FIG. 15) in first latch release member 320 moves by moving first latch release member 320 in a direction away from adapter body 310 (PULL direction in FIG. 11), and the locking of first optical connector 100 locked to adapter body 310 is released. Details will be described later. After releasing, first latch release member 320 is returned toward adapter body 310, which is the initial position, by the urging of first elastic member 340. It is noted that, second latch release member 350 and second guide member 360 have the same configuration as first latch release member 320 and first guide member 330 described above, are provided on the opposite side in insertion/attaching and detaching direction A, and are configured to perform the same latch release action.

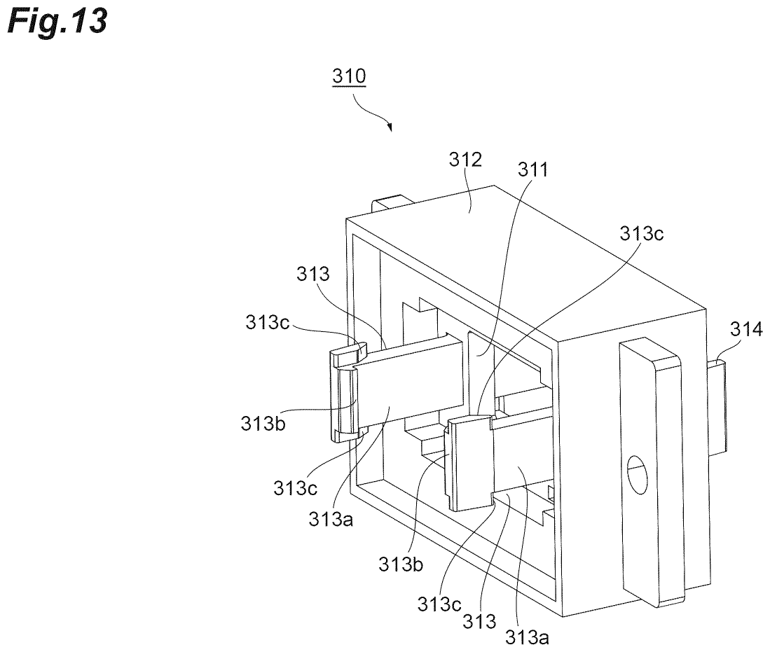

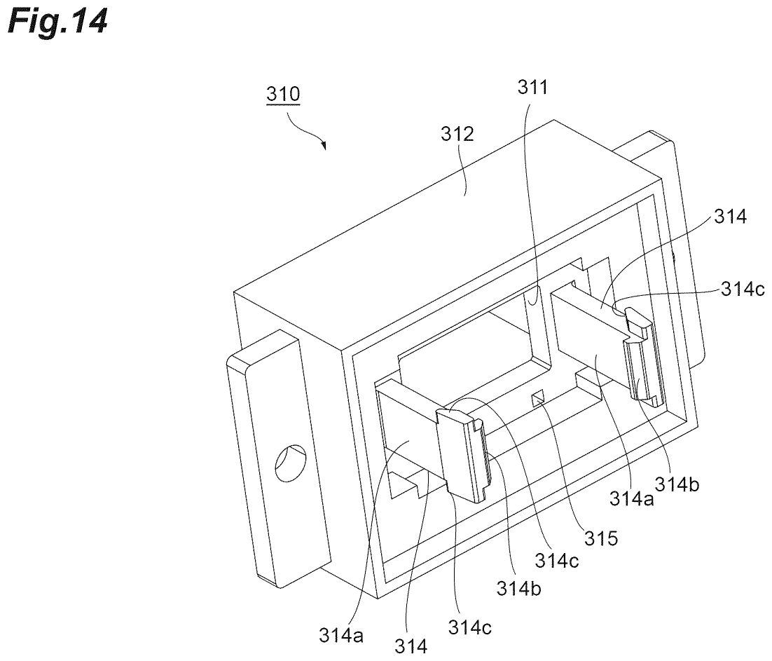

FIG. 13 is a perspective view showing an adapter body of the adapter shown in FIG. 11. FIG. 14 is a perspective view of the adapter body as viewed from another angle shown in FIG. 13. As shown in FIG. 11 to FIG. 14, adapter body 310 includes a frame 312 having an opening 311 on the inside, a pair of first latch members 313, and a pair of second latch members 314. The pair of first latch member 313 and the pair of second latch member 314 are arranged on opposite sides with frame 312 interposed therebetween and extend toward the opposite sides. First latch members 313 are provided on both edges of one surface of opening 311 of frame 312, and include a first latch body 313a extending from frame 312 along insertion/attaching and detaching direction A of first optical connector 100, and a first protruding portion 313b protruding from a tip of first latch body 313a to the inside along a lateral direction perpendicular (intersect) to insertion/attaching and detaching direction A. When first optical connector 100 is inserted into adapter 300, both first protruding portions 313b are engaged with latch receiving portions 125 (refer to FIG. 4) of first optical connector 100 to lock first optical connector 100 to adapter 300.

Each of first latch members 313 further includes a pair of second latch release structures 313c provided on both sides of first protruding portion 313b in the up-and-down direction. Second latch release structure 313c has an inclined surface that extends outward in a direction toward frame 312. When first latch release member 320 is moved in a direction away from adapter body 310, first latch release structure 322 of first latch release member 320 moves to climb up the inclined surface of second latch release structure 313c, and pushes first latch member 313 outward in the lateral direction. Each protruding portion 313b is also pushed outward in accordance with the pushing operation, and thus the locking of first optical connector 100 locked by first latch member 313 is released.

Second latch member 314 has the same configuration as first latch member 313, but is disposed and extends at a position that is opposite to first latch member 313 in insertion/attaching and detaching direction A. Second latch member 314 is provided on both edges of the surface of opening 311 of frame 312 opposite to first latch member 313, and includes a second latch body 314a extending from frame 312 along insertion/attaching and detaching direction A of second optical connector 200 and a second protruding portion 314b protruding from the tip of second latch body 314a to the inside along the lateral direction perpendicular to insertion/attaching and detaching direction A. Second optical connector 200 is locked to adapter 300 by engaging both of second protruding portions 314b with latch receiving portions 225 (refer to FIG. 4) of second optical connector 200.

Each of second latch members 314 further includes a pair of fourth latch release structures 314c provided on both sides of second protruding portion 314b in the up-and-down direction, similarly to first latch member 313. Fourth latch release structures 314c have an inclined surface. Fourth latch release structures 314c have an inclined surface that extends outward in a direction toward frame 312. When second latch release member 350 is moved in a direction away from adapter body 310, a third latch release structure 352 of second latch release member 350 moves to climb up the inclined surface of fourth latch release structure 314c, and pushes second latch member 314 outward in the lateral direction. Each protruding portion 314b is also pushed outward in accordance with the pushing operation, and thus the locking of second optical connector 200 locked by second latch member 314 is released.

First latch release member 320 is attached to be movable along insertion/attaching and detaching direction A with respect to adapter body 310, and has two pairs of first latch release structures 322. FIG. 15 is a perspective view showing a latch release member. As shown in FIG. 15, first latch release structures 322 of first latch release member 320 include inclined surfaces 322a each facing outward. Inclined surfaces 322a come into contact with the inclined surfaces of second latch release structure 313c of first latch member 313 and push the inclined surfaces outward to release the locking of first optical connector 100 locked by first latch member 313. The distance between inclined surfaces 322a of the pair of first latch release structures 322 (the distance in the up-and-down direction) is wider than the length of protruding portion 313b of first latch member 313 in the up-and-down direction, and first latch release member 320 is configured such that protruding portions 313b are freely extended outward (pushed out) when the above-described operation of releasing the locking is performed.

As shown in FIG. 11 and FIG. 12, first guide member 330 is a member that regulates a distance by which first latch release member 320 moves in a direction away from adapter body 310 along insertion/attaching and detaching direction A and guides the insertion of first optical connector 100 into adapter 300. First guide member 330 has four guide surfaces 332 defining an opening 331 provided on the front side. When first optical connector 100 is inserted into adapter 300, four guide surfaces 332 are guided to come into contact with four surfaces 122a to 122d of first optical connector 100.

A restricting structure 334 for restricting the insertion posture of first optical connector 100 inserted into and guided by first guide member 330 may be provided on one guide surface 332 (an upper surface in FIG. 11) of first guide member 330. Restricting structure 334 is, for example, a protruding portion extending along insertion/attaching and detaching direction A, and is inserted into groove 124 provided at an upper portion of first optical connector 100. The insertion posture of first optical connector 100 inserted into adapter 300 may be easily determined by restricting structure 334. It is noted that the reason why such insertion posture is regulated is that a leading end surface 112 of ferrule 110 held by first optical connector 100 is inclined and that the inclined surface of ferrule 210 which is held by second optical connector 200 and leading end surface 212 is inclined in and the inclined surface of first ferrule 110 are made to be along (parallel to) each other when optically coupled. In this way, when only the up-and-down direction is required to be known, restricting structure 334 may be provided only on one surface of four guide surfaces 332. It should be noted that two or more guide surfaces 332 may be provided with restricting structures 334 having different heights.

First guide member 330 further has four insertion protrusions 336 at the rear end. These insertion protrusions 336 are inserted into four fixing holes 315 (refer to FIG. 14) provided near the outer periphery of opening 311 of adapter body 310, and thereby first guide member 330 is fixed to adapter body 310. Four fixing holes 315 are provided at positions corresponding to each insertion protrusion 336. Further, first guide member 330 also has elastic member receiving portions 338 at the upper surface of the outer periphery thereof. First elastic member 340 is disposed in any one of the grooves of elastic member receiving portions 338, and first guide member 330 is fixed to adapter body 310 with first latch release member 320 interposed therebetween. In this case, the tip of first elastic member 340 is in contact with a front end wall 338a of elastic member receiving portion 338 of first guide member 330, and the rear end of first elastic member 340 is in contact with a rear end wall 324a of a recess 324 of first latch release member 320. In the example of the drawing, one spring is arranged on each of the upper and lower sides as first elastic member 340, but three springs may be arranged on each of the upper and lower sides. Note that first elastic member 340 may not be provided.

Second latch release member 350 has the same configuration as first latch release member 320, and is disposed on the opposite side of first latch release member 320 through adapter body 310. Second latch release member 350 is attached to be movable along insertion/attaching and detaching direction A with respect to adapter body 310, and has two pairs of third latch release structures 352. As shown in FIG. 15, third latch release structures 352 of second latch release member 350 include inclined surfaces 352a each facing outward. These inclined surfaces 352a come into contact with the inclined surfaces of fourth latch release structures 314c of second latch member 314 and push the inclined surfaces outward to release the locking of second optical connector 200 locked by second latch member 314. The distance between the inclined surfaces of the pair of third latch release structures 352 is wider than the distance between second protruding portions 314b of second latch member 314 in the up-and-down direction, and second latch release member 350 is configured such that second protruding portions 314b are freely extended outward (pushed out) when the above-described operation of releasing the locking is performed.

Second guide member 360 has the same configuration as first guide member 330 and, as shown in FIG. 11 and FIG. 12, is a member that regulates the distance by which second latch release member 350 moves in a direction away from adapter body 310 along the insertion/attaching and detaching direction A and guides the insertion of second optical connector 200 into adapter 300. Second guide member 360 has four guide surfaces defining an opening 361 provided on the front side. A restricting structure for restricting the insertion posture of second optical connector 200 inserted into and guided by second guide member 360 may be provided on one of the guide surfaces, similarly to first guide member 330. However, the restricting structure is provided at a position (for example, the lower surface) which is vertically opposite to restricting structure 334 of first guide member 330. With this arrangement, the inclined surfaces of the leading end surfaces of first optical connector 100 and second optical connector 200 coincide with each other.

Second guide member 360 has four insertion protrusions 366 at the rear end. These insertion protrusions 366 are inserted into four fixing holes 315 (refer to FIG. 14) provided near the outer periphery of opening 311 of adapter body 310, and thereby second guide member 360 is fixed to adapter body 310. Four fixing holes 315 are provided at positions corresponding to each insertion protrusion 366. Second guide member 360 also has elastic member receiving portions 368 at an upper surface of the outer periphery thereof. Second elastic member 370 is disposed in any one of the grooves of elastic member receiving portions 368, and second guide member 360 is fixed to adapter body 310 with second latch release member 350 interposed therebetween. In this case, the tip of second elastic member 370 is in contact with a front end wall 368a of elastic member receiving portion 368 of second guide member 360, and the rear end of second elastic member 370 is in contact with the rear end wall of the recess of second latch release member 350.

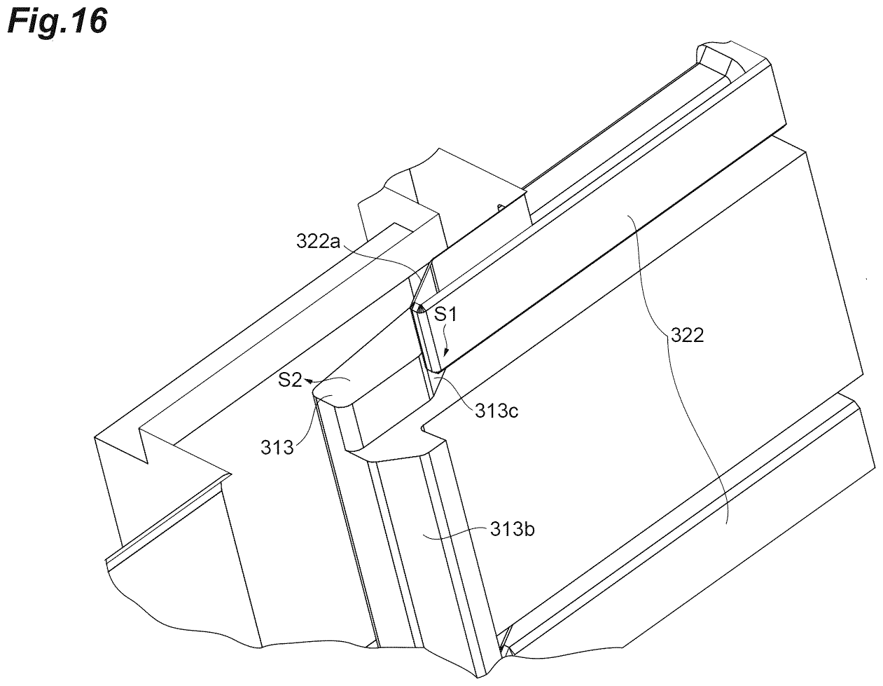

Referring to FIG. 16, the operation of releasing the latch of first optical connector 100 inserted into adapter 300 and locked by the latch member in optical connection structure 1 according to the embodiment of the present disclosure will be described. Second optical connector 200 inserted into adapter 300 and locked by the latch member performs the same latch release operation, and thus a description thereof will be omitted.

First, in order to release the latch, first latch release member 320 is moved in a direction away from adapter body 310 along insertion/attaching and detaching direction A. Then, inclined surface 322a of first latch release structure 322 provided inside first latch release member 320 enters inside (an arrow S1) and comes into contact with second latch release structure 313c of first latch release member 313. Thereafter, when first latch release member 320 is further moved in the direction away from adapter body 310, first latch release structure 322 is further moved, and the region including protruding portion 313b of first latch member 313 is moved so as to be pushed outward in the lateral direction (an arrow S2). Thus, protruding portion 313b of first latch member 313, which is engaged with latch receiving portion 125 of first optical connector 100, is disengaged from latch receiving portion 125, and first optical connector 100 can be removed from adapter 300. When first optical connector 100 is removed from adapter 300, first latch release member 320 is returned to the initial position by first elastic member 340. The above-described operation is performed simultaneously in each first latch release structure 322.

As described above, in optical connection structure 1, the latch release mechanism for releasing the locking of first optical connector 100 locked to adapter 300 is provided in adapter 300. According to this embodiment, the latch release mechanism, which tends to increase the size of the structure and the size of the device, does not have to be provided in first optical connector 100, and thus first optical connector 100 can be miniaturized. When first optical connector 100 is small, first optical connector 100 that is attachable and detachable is improved in the routing property in the application of connecting to adapter 300 or the like through a narrow place. Thus, the working efficiency can be improved when first optical connector 100 is attached to adapter 300.

In the embodiment of the present disclosure, adapter 300 includes adapter body 310 having a pair of first latch members 313 for locking first optical connector 100, and first latch release member 320 having two pairs of first latch release structures 322 and attached to be movable along insertion/attaching and detaching direction A with respect to adapter body 310. The two pairs of first latch release structure 322 constitutes a portion of a latch release mechanism, and when first latch release member 320 moves in a direction away from adapter body 310 along insertion/attaching and detaching direction A, the locking of first optical connector 100 locked to adapter 300 is released. Thus, the locking of first optical connector 100 can be released by a simple means in adapter 300.

In the embodiment of the present disclosure, adapter body 310 further includes frame 312 having opening 311 inside. Each of the pair of first latch members 313 includes first latch body 313a extending outward from frame 31 along insertion/attaching and detaching direction A and first protruding portion 313b protruding inward from the tip of first latch body 313a. First protruding portion 313b is engaged with latch receiving portion 125 of first optical connector 100 to lock first optical connector 100 to adapter 300. With such a configuration, adapter 300 can lock first optical connector 100 thereto by a simple means.

In the embodiment of the present disclosure, the latch release mechanism described above is configured to move first protruding portion 313b of each of the pair of first latch members 313 outward when first latch release member 320 moves in a direction away from adapter body 310 along insertion/attaching and detaching direction A. According to such a configuration, the locking of first optical connector 100 can be released by a simple means in adapter 300.

In the embodiment of the present disclosure, each of the pair of first latch members 313 may have the pair of second latch release structures 313c provided on both sides of first protruding portion 313b, and the two pairs of first latch release structures 322 and the pair of second latch release structures 313c of each of the pair of first latch members 313 may constitute a latch release mechanism. In optical connection structure 1, when first latch release member 320 moves in a direction away from adapter body 310 along insertion/attaching and detaching direction A, the two pairs of first latch release structures 322 come into contact with the pair of second latch release structures 313c of each of the pair of first latch members 313 and push first protruding portion 313b outward to release the locking of first optical connector 100 locked to adapter 300. With such a configuration, the locking of first optical connector 100 can be more reliably released in adapter 300.

In the embodiment of the present disclosure, adapter 300 further includes first guide member 330 configured to restrict a distance by which first latch release member 320 moves in a direction away from adapter body 310 along insertion/attaching and detaching direction A and guide the insertion of first optical connector 100 into adapter 300. By limiting the moving range of first latch release member 320 in this way, the latch release operation can be performed in a narrow range, and first optical connector 100 can be smoothly inserted into adapter 300.

In the embodiment of the present disclosure, elastic member 340 is disposed between first latch release member 320 and first guide member 330, and elastic member 340 acts to return first latch release member 320 toward adapter body 310 after first latch release member 320 moves in a direction away from adapter body 310. With such a configuration, the return motion after the locking of first optical connector 100 is released can be realized by a simple means in adapter 300.

In the embodiment of the present disclosure, first guide member 330 is provided with restricting structure 334 for restricting the insertion posture of first optical connector 100 with respect to adapter 300. For example, the end surface of ferrule 110 held by first optical connector 100 may be an inclined surface for preventing reflected return light or the like. In this case, it is necessary to connect first optical connector 100 to adapter 300 or optically couple first optical connector 100 to second optical connector 200 in a state where the posture of first optical connector 100 in the up-and-down direction is adjusted. In this embodiment, since the structure for regulating such a posture is pre-provided in adapter 300, there is no risk of inserting the first optical connector into the adapter in the wrong posture. As described above, according to the embodiment of the present disclosure, since it is not necessary to care about the posture such as the up-and-down direction when first optical connector 100 is inserted into adapter 300, the working efficiency can be improved when first optical connector 100 is attached to adapter 300.

In the embodiment of the present disclosure, a second latch release mechanism for releasing the locking of second optical connector 200 locked to adapter 300 may be provided in adapter 300. According to this embodiment, the latch release mechanism, which tends to increase the size of the structure and the size of the device, does not have to be provided in second optical connector 200, and thus second optical connector 200 can also be miniaturized. When second optical connector 200 is small, the routing property of second optical connector 200 is also improved in the application of connecting to the adapter or the like through a narrow place. The working efficiency can be improved when second optical connector 200 is attached to adapter 300 or the like. It is noted that, the structure for locking second optical connector 200 to adapter 300 is the same as the structure for locking first optical connector 100 to adapter 300, and the same effect can be achieved.

In the embodiment of the present disclosure, latch receiving portions 125 and 225 are formed in optical connectors 100 and 200 as a configuration for being locked to adapter 300, respectively. Since latch receiving portions 125 and 225 are simpler in configuration and more easily miniaturized than the latch member, the optical connector attachable to and detachable from adapter 300 may be miniaturized according to the configuration. When the optical connector is small, the routing property of the optical connector is improved in the application where the optical connector is connected to the adapter or the like through a narrow space. The working efficiency can be improved when the optical connector is attached to the adapter or the like.

In the embodiment of the present disclosure, latch receiving portions 125 and 225 of optical connectors 100 and 200 are holes or recess provided in a wall constituting front connector housings 120 and 220, respectively. With this configuration, optical connectors 100 and 200 attachable to and detachable from adapter 300 can be more reliably miniaturized.

In the embodiment of the present disclosure, front connector housings 120 and 220 of optical connectors 100 and 200 have at least two or more guide surfaces on the outer peripheral surface thereof, at least two or more guide surfaces being configured to be extend along the inner peripheral surface of adapter 300. In addition, no protruding portion or the like is formed in a region of at least two or more guide surfaces, the region being a region to be inserted into adapter 300. That is, the configuration to protrude outward is not included. With such a configuration, optical connectors 100 and 200 can be connected to adapter 300 more appropriately, and optical connectors 100 and 200 can be miniaturized.

In the embodiment of the present disclosure, on the outer peripheral surface of front connector housings 120 and 220 of optical connector 100 and 200, grooves 124 and 224 which are the restricting structure configured to restrict the posture of optical connectors 100 and 200 when optical connectors 100 and 200 are inserted into adapter 300 are provided. According to such a configuration, the posture of optical connectors 100 and 200 can be easily adjusted when optical connectors 100 and 200 are inserted into adapter 300, and the attaching work can be facilitated.

In the embodiment of the present disclosure, the plurality of ferrules 110 and 210 of optical connectors 100 and 200 has leading end surfaces 112 and 212 on which the plurality of optical fibers F1 and F2 are exposed, and leading end surfaces 112 and 212 include second surfaces 112b and 212b (inclined surfaces) inclined with respect to a plane orthogonal to an extending direction of a holding hole that holds the plurality of optical fibers F1 and F2, respectively. In optical connectors 100 and 200, the plurality of ferrules 110 and 210 may be held in the connector housing such that all of second surfaces 112b and 212b (inclined surfaces) are positioned on one inclined surface. In this case, since all of the inclined surfaces which are main surfaces in the plurality of ferrules 110 and 210 constitute one surface, the inclined surfaces can be easily and reliably cleaned before optical connectors 100 and 200 are optically coupled to another optical connector. The coupling efficiency of the optical connector can be increased.

In the embodiment of the present disclosure, the connector housing of the optical connector includes front connector housing 120 positioned at a front side thereof and having a rectangular parallelepiped shape and rear connector housing 130 positioned at a rear side thereof. Front connector housing 120 has a plurality of ferrule housing holes 121 and 221 for each housing a corresponding one of the plurality of ferrules 110 and 210, respectively. Front connector housing 120 has four guide surfaces on the outer peripheral surface thereof, the four guide surfaces being formed to extend along the inner peripheral surface of the adapter, and no protruding portion is formed in at least a region of the four guide surfaces, the region being a region to be inserted into the adapter. With such a configuration, optical connectors 100 and 200 can be miniaturized.

In the embodiment of the present disclosure, optical connectors 100 and 200 further include the plurality of urging members 150 and 250 configured to urge the plurality of ferrules 110 and 210 forward, and housing members 140 and 240 configured to receive rear ends of the plurality of urging members 150 and 250 and house the plurality of urging members 150 and 250, respectively. Housing members 140 and 240 have first housing regions 141 and 241 configured to house one or more urging members of the plurality of urging members 150 and 250, second housing regions 142 and 242 configured to house one or more other urging members of the plurality of urging members 150 and 250, and the plurality of fiber insertion holes 143 and 243 corresponding to the plurality of ferrules 110 and 210, each of fiber insertion holes 143 and 243 being configured to allow the plurality of optical fibers F1 and F2 held by a corresponding one of the plurality of ferrules 110 and 210 to pass therethrough, respectively. With such a configuration, a large number of optical fibers can be installed in one optical connector at a high density.

Although the embodiments of the present disclosure have been described in detail, the present invention is not limited to the embodiments described above, and can be applied to various embodiments.

### REFERENCE SIGNS LIST

1 optical connection structure
100 first optical connector
   101, 201 leading end surface
   110, 210 ferrule
      111, 211 fiber holding hole
      112, 212 leading end surface
      112a, 212a first surface
      112b, 212b second surface (inclined surface)
      113, 213 guiding hole
      114, 214 opening
      115, 215 main body
      116, 216 flange
      117, 217 front end portion
   120, 220 front connector housing (connector housing)
      121, 221 ferrule housing hole
      121a, 221a edge portion
      122a to 122d, 222a to 222d surface (guide surface)
      123, 223 opening
      124, 224 groove (restricting structure)
      125, 225 latch receiving portion
      126, 226 leading end surface
   130, 230 rear connector housing
      131, 231 front portion
      132, 232 rear portion
      133, 233 engaging protrusion
   140, 240 housing member
      141, 241 first housing region
      142, 242 second housing region
      143, 243 fiber insertion hole
   150, 250 urging member
   160, 260 pin keeper
200 second optical connector
300 adapter
   310 adapter body
      311 opening
      312 frame
      313 first latch member
      313a first latch body
      313b first protruding portion
      313c second latch release structure
      314 second latch member
      314a second latch body
      314b second protruding portion
      314c fourth latch release structure
      315 fixing hole
   320 first latch release member
      322 first latch release structure
      322a inclined surface
      324 recess
      324a rear end wall
   330 first guide member
      331, 361 opening
      332 guide surface
      334 restricting structure
      336, 366 insertion protrusion
      338, 368 elastic member receiving portion
      338a, 368a front end wall
   340 first elastic member
   350 second latch release member
      352 third latch release structure
      352a inclined surface
      354 recess
      354a rear end wall
   360 second guide member
   370 second elastic member
A axial direction, insertion/attaching and detaching direction
F1, F2 optical fiber
S reference inclined surface
S1, S2 arrow

1. An optical connection structure comprising:
a first optical connector including a plurality of first ferrules each configured to hold a plurality of first optical fibers, and a first connector housing configured to house and hold the plurality of first ferrules;
a second optical connector including a plurality of second ferrules each configured to hold a plurality of second optical fibers, and a second connector housing configured to house and hold the plurality of second ferrules; and
an adapter having a tubular shape and configured such that the first optical connector and the second optical connector are locked to the adapter in such a manner that the first optical connector and the second optical connector inserted into the tubular shape face each other inside the tubular shape to optically couple each of the plurality of first optical fibers to a corresponding optical fiber of the plurality of second optical fibers, wherein
the adapter is provided with a first latch release mechanism configured to release locking of the first optical connector locked to the adapter.

2. The optical connection structure according to claim 1, wherein
the adapter includes:
an adapter body including a first latch member configured to lock the first optical connector; and
a first latch release member to be attached to the adapter body in such a manner as to be movable along a first direction, the first latch release member including a first latch release structure, and
the first latch release structure constitutes a portion of the first latch release mechanism and is configured to release locking of the first optical connector locked to the adapter when the first latch release member moves in a direction away from the adapter body along the first direction.

3. The optical connection structure according to claim 2, wherein
the first latch member includes a pair of first latch members, and
the first latch release structure includes two pairs of first latch release structures.

4. The optical connection structure according to claim 2, wherein
the adapter body further includes a frame having an opening thereinside,
the first latch member includes a first latch body extending outward from the frame along the first direction, and a first protruding portion protruding inward from a tip of the first latch body along a second direction intersecting the first direction, and
the first protruding portion engages with a latch receiving portion of the first optical connector to lock the first optical connector to the adapter.

5. The optical connection structure according to claim 4, wherein
the first latch release mechanism is configured to move the first protruding portion of the first latch member outward when the first latch release member moves in the direction away from the adapter body along the first direction.

6. The optical connection structure according to claim 4, wherein
the first latch member includes a second latch release structure provided beside the first protruding portion,
the first latch release structure and the second latch release structure constitute the first latch release mechanism, and
when the first latch release member moves in the direction away from the adapter body along the first direction, the first latch release structure comes into contact with the second latch release structure and pushes the first protruding portion outward to release the locking of the first optical connector locked to the adapter.

7. The optical connection structure according to claim 2, wherein
the adapter further includes a first guide member configured to restrict a distance by which the first latch release member moves in the direction away from the adapter body along the first direction and guide insertion of the first optical connector into the adapter.

8. The optical connection structure according to claim 7, wherein
an elastic member is disposed between the first latch release member and the first guide member, the elastic member acting to return the first latch release member toward the adapter body after the first latch release member moves in the direction away from the adapter body.

9. The optical connection structure according to claim 7, wherein
the first guide member is provided with a restricting structure configured to restrict an insertion posture of the first optical connector with respect to the adapter.

10. The optical connection structure according to claim 2, wherein
the adapter is provided with a second latch release mechanism configured to release locking of the second optical connector locked to the adapter.

11. The optical connection structure according to claim 10, wherein
the adapter includes:
a second latch release member to be attached to the adapter body at a position on an opposite side of the adapter body to a first latch release member along a first direction in such a manner as to be movable along the first direction, the second latch release member including two pairs of third latch release structures; and
a second guide member configured to restrict a distance by which the second latch release member moves in a direction away from the adapter body along the first direction and guide insertion of the second optical connector into the adapter,
the adapter body includes a pair of second latch members configured to lock the second optical connector,
each of the pair of second latch members includes a second latch body extending along the first direction, a second protruding portion protruding inward from a tip of the second latch body along a second direction intersecting the first direction, and a pair of fourth latch release structures provided on both sides of the second protruding portion,
the two pairs of third latch release structures and the pair of fourth latch release structures of each of the pair of second latch members constitute the second latch release mechanism, and
when the second latch release member moves in the direction away from the adapter body along the first direction, the two pairs of third latch release structures come into contact with the pair of fourth latch release structures of each of the pair of second latch members and push the second protruding portion outward to release the locking of the second optical connector locked to the adapter.

12. An adapter to which a first optical connector holding a plurality of first ferrules and a second optical connector holding a plurality of second ferrules are to be locked, the adapter comprising:
an adapter body having a first latch member configured to lock the first optical connector; and
a first latch release member to be attached to the adapter body in such a manner as to be movable along a first direction, the first latch release member including a first latch release structure, wherein
the first latch release structure is configured to release locking of the first optical connector locked to the adapter by the first latch member when the first latch release member moves in a direction away from the adapter body along the first direction.

13. The adapter according to claim 12, wherein
the first latch member includes a pair of first latch members, and
the first latch release structure includes two pairs of first latch release structures.

14. The adapter according to claim 12, wherein
the adapter body further includes a frame having an opening thereinside,
the first latch member includes a first latch body extending outward from the frame along the first direction, and a first protruding portion protruding inward from a tip of the first latch body along a second direction intersecting the first direction, and
the first protruding portion engages with a latch receiving portion of the first optical connector to lock the first optical connector to the adapter.

15. The adapter according to claim 14, wherein
the first latch member includes a second latch release structure provided beside the first protruding portion, and
when the first latch release member moves in the direction away from the adapter body along the first direction, the first latch release structure comes into contact with the second latch release structure and pushes the first protruding portion outward to release the locking of the first optical connector locked to the adapter.

16. The adapter according to claim 14, further comprising
a first guide member configured to restrict a distance by which the first latch release member moves in the direction away from the adapter body along the first direction and guide insertion of the first optical connector into the adapter.

17. The adapter according to claim 16, wherein
an elastic member is disposed between the first latch release member and the first guide member, the elastic member acting to return the first latch release member toward the adapter body after the first latch release member moves in the direction away from the adapter body.

18. The adapter according to claim 16, wherein
the first guide member is provided with a restricting structure configured to restrict an insertion posture of the first optical connector with respect to the adapter.

19. The adapter according to claim 12, further comprising:
a second latch release member disposed at a position on an opposite side of the adapter body to the first latch release member along the first direction, the second latch release member being to be attached to the adapter body in such a manner as to be movable along the first direction, the second latch release member including two pairs of third latch release structures; and
a second guide member configured to restrict a distance by which the second latch release member moves in the direction away from the adapter body along the first direction and guide insertion of the second optical connector into the adapter, wherein
the adapter body includes a pair of second latch members configured to lock the second optical connector,
each of the pair of second latch members includes a second latch body extending along the first direction, a second protruding portion protruding inward from a tip of the second latch body along a second direction intersecting the first direction, and a pair of fourth latch release structures provided on both sides of the second protruding portion, and
when the second latch release member moves in the direction away from the adapter body along the first direction, the two pairs of third latch release structures come into contact with the pair of fourth latch release structures of each of the pair of second latch members and push the second protruding portion outward to release locking of the second optical connector locked to the adapter.

20. An optical connector to be inserted into and locked to an adapter having a tubular shape, the optical connector comprising:
a plurality of ferrules each configured to hold a plurality of optical fibers; and
a connector housing configured to house and hold the plurality of ferrules, wherein
the connector housing has formed therein a latch receiving portion to which a latch member of the adapter is to be locked.

21. (canceled)

22. The optical connector according to claim 20, wherein
the connector housing includes at least two or more guide surfaces on an outer peripheral surface thereof, the at least two or more guide surfaces being configured to extend along an inner peripheral surface of the adapter, and
no protruding portion is formed in a region of the at least two or more guide surfaces, the region being a region to be inserted into the adapter.

23. The optical connector according to claim 20, wherein
the connector housing is provided with, on an outer peripheral surface thereof, a restricting structure configured to restrict a position of the optical connector when the optical connector is inserted into the adapter, the restricting structure having a recessed shape.

24. The optical connector according to claim 20, wherein
each of the plurality of ferrules includes a leading end surface from which the plurality of optical fibers are exposed, the leading end surface being inclined with respect to a plane orthogonal to a first direction, the first direction being an extending direction of a holding hole configured to hold the plurality of optical fibers, and
the plurality of ferrules are held in the connector housing such that all of the leading end surfaces of the plurality of ferrules are positioned on one inclined surface.

25. The optical connector according to claim 20, wherein
the connector housing includes a front connector housing positioned at a front side thereof and having a rectangular parallelepiped shape, and a rear connector housing positioned at a rear side thereof,
the front connector housing includes a plurality of ferrule housing holes each configured to house a corresponding one of the plurality of ferrules,
the front connector housing includes four guide surfaces on an outer peripheral surface thereof, the four guide surfaces being formed to extend along an inner peripheral surface of the adapter, and
no protruding portion is formed in at least a region of the four guide surfaces, the region being a region to be inserted into the adapter.

26. The optical connector according to claim 20, further comprising:
a plurality of urging members configured to urge the plurality of ferrules forward; and
a housing member configured to receive rear ends of the plurality of urging members and house the plurality of urging members, wherein
the housing member includes a first housing region configured to house one or more urging members of the plurality of urging members, a second housing member configured to house one or more other urging members of the plurality of urging members, and a plurality of fiber insertion holes corresponding to the plurality of ferrules, each of the plurality of fiber insertion holes being configured to allow the plurality of optical fibers held by a corresponding one of the plurality of ferrules to pass therethrough.
